(19) United States
(12) Patent Application Publication
(10) Pub. No.: US 2025/0030214 A1
(43) Pub. Date: Jan. 23, 2025

(54) ELECTRO-MECHANICAL QUICK CONNECTOR WITH INTEGRAL ACCESS TOOL

(71) Applicant: Raytheon Company, Waltham, MA (US)

(72) Inventor: Brian D. Leapley, Madison, AL (US)

(21) Appl. No.: 18/353,499

(22) Filed: Jul. 17, 2023

(51) Int. Cl. H01R 43/26; H01R 13/447

(52) U.S. Cl. CPC H01R 43/26; H01R 13/447; F42C 17/00

(57) ABSTRACT

An electro-mechanical tool includes a handheld housing, an electrical cable, and an electro-mechanical head. The electro-mechanical head includes an electrical connector and a tool subassembly. The electrical connector includes pins, each pin connected to a lead of the electrical cable. The tool subassembly includes a bit attached to a cap, which is distally located relative to the electrical connector.

### STATEMENT OF GOVERNMENT INTEREST

This invention was made with government support under The Department of Defense Ordnance Technology Consortium Initiative Agreement DOTC-19-04-INIT4411 awarded by Advanced Technology International. The government has certain rights in the invention.

### BACKGROUND

The present disclosure relates generally to multi-functional tools and, more specifically, to tools with mechanical and electrical features.

Some devices require mechanical operations and electrical operations to fully utilize the device in the field. Typically, different tools are required to perform mechanical tasks and electrical tasks. These single-function tools can be separated from each other in the field, and thereby prevent an operator from fully utilizing the device.

One such device is a munition, which is designed to be launched from a weapon system. Some munitions require access to an electrical receptacle for passing power and data parameters from a fuze setter. However, an access cover protects the electrical receptacle and blocks access to the electrical receptacle. To prepare the munition for launch, the access cover must be removed such that power and data parameters can be transferred to the munition via the electrical receptacle. Requiring different tools to remove the access cover and set the fuze of the munition increases the risk that one or the other tasks cannot be completed.

### SUMMARY

A tool according to an example of this disclosure includes a handheld housing, an electrical cable, and an electro-mechanical head, which includes a tool subassembly and an electrical connector. The electro-mechanical head extends along an axis from the handheld housing to a distal end. The housing functions as a level arm to apply torque to the electro-mechanical head about the axis. The electrical connector includes pins connected to respective leads of the cable, which extends through the housing and the electro-mechanical head to the fuze setter. The tool subassembly includes a bit attached to a cap. The bit of the tool subassembly is distally located relative to the electrical connector.

In a further example, the tool can include an electro-mechanical head that includes a shaft, a collar, a snap ring, and a spring. The shaft attaches to the housing and extends towards the distal end of the tool along the axis. A groove of the shaft receives the snap ring. The collar is coaxial with the shaft, which is biased towards the snap ring by the spring. The collar circumscribes and extends distally of the electrical connector and tool subassembly.

In a further example, the tool includes a locking mechanism operatively associated with the tool subassembly. The locking mechanism can include a tube, an actuation shaft, a spring, a locking cam, and balls. The actuation shaft extends through the tube, the handheld housing, and the electro-mechanical head into the tool subassembly. The locking cam attaches to the end of the actuation shaft and engages the balls in a locked position and retracts the balls in a disengaged position.

In a further example, the tool includes a dust cover that encloses an open end of the electro-mechanical head. The electro-mechanical head can include a retainer attached to the collar at the distal end of tool. The dust cover can be retained between the retainer and the collar.

### BRIEF DESCRIPTION OF THE DRAWINGS

FIG. 1 is an isometric view of an electro-mechanical tool.

FIG. 2 is an enlarged view of the electro-mechanical tool of FIG. 1 depicting details of an electrical connector and a tool subassembly of the electro-mechanical tool.

FIG. 3 is an end view of the electro-mechanical tool as depicted in FIG. 2.

FIG. 4 is a cross-sectional view of the electro-mechanical tool of FIG. 1.

FIG. 5 is an exploded view of the electro-mechanical tool of FIG. 1.

FIG. 6A, FIG. 6B, FIG. 6C, and FIG. 6D depict a sequence of using the electro-mechanical tool of FIG. 1.

### DETAILED DESCRIPTION

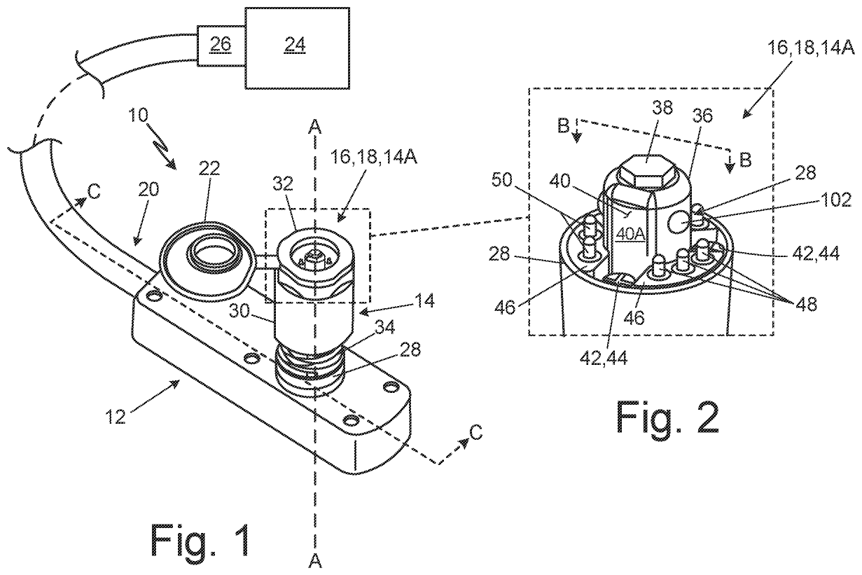

FIG. 1 is an isometric view of tool 10. Tool 10 includes housing 12, electro-mechanical head 14, tool subassembly 16, electrical connector 18, cable 20, dust cover 22, computing device 24, and external connector 26. Tool 10 includes axis A, which extends through the geometry centers of electro-mechanical head 14, tool subassembly 16, and electrical connector 18. In the following description, references to “axial” or “axially” relate to directions parallel to axis A. “Lateral”, “laterally”, “radial”, or “radially” refer to directions perpendicular to axis A.

Tool 10 is a multi-functional tool that allows a mechanical task and an electrical task to be performed using tool subassembly 16 and electrical connector 18 respectively. Example mechanical tasks include tightening or loosening mechanical fasteners or removing and/or replacing access covers blocking an electrical receptacle. Once exposed, electrical connector 18 can interface with the host device receptacle to provide power and/or transfer data between computing device 24 and the host device.

Housing 12 is a hollow shell that encloses an interior space and facilitates hand operation of tool 10. Housing 12 extends radially from axis A such that hand application of force to housing 12 applies torque about axis A to tool subassembly 16 in proportion to the applied force and effective moment arm. While the example depicted in FIG. 1 has a longitudinal dimension perpendicular to axis A, portions of housing 12 can extend at oblique angles or parallel to axis A while imposing torque to tool subassembly 16 that is equivalent to the depicted example. As shown in FIG. 1, housing 12 has a rectangular cross-section along the longitudinal direction in which the size of the cross-section fits within an operator's hand. In other examples, the exterior of housing 12 can be organically and ergonomically contoured along the longitudinal direction to define a hand grip.

Electro-mechanical head 14 attaches to housing 12 and extends along axis A to distal end 14A. As depicted in FIG. 1, electro-mechanical head 14 includes shaft 28, collar 30, retainer 32, and spring 34. Electro-mechanical head 14 also includes tip 16 and electrical connector 18, which received within a bore of shaft 28 at distal end 14A. Cable 20 electrically connects electrical connector 18 to computing device 24. Cable 20 extends through electro-mechanical head 14 and housing 12 to external connector 26, which interfaces with a mating receptacle of computing device 24. Computing device 24 provides power and/or transfers data through cable 20 and electrical connector 18 to a device, or vice versa. External connector 26 can be any commercially available electrical connector suitable for interfacing with computing device 24.

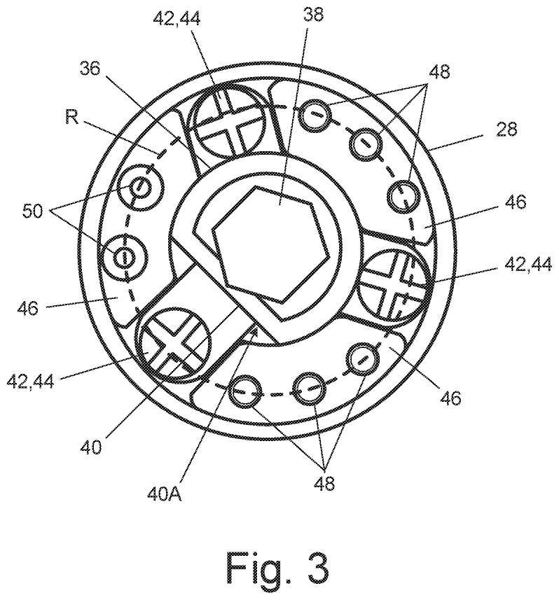

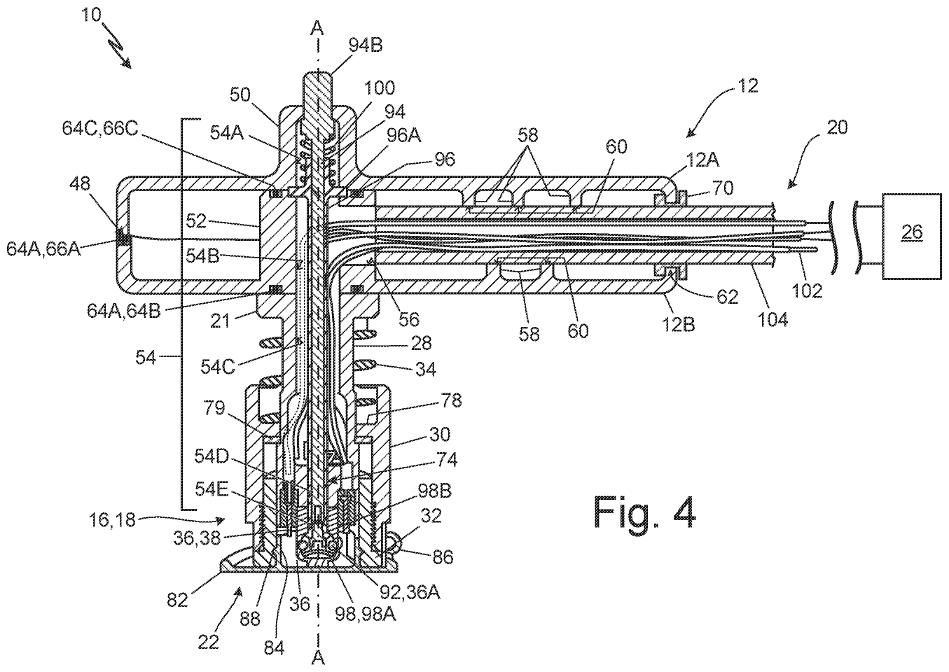

FIG. 2 is an enlarged isometric view of distal end 14A of electro-mechanical head 14. FIG. 3 is an end view of electro-mechanical head 14 taken along section B-B in FIG. 2. Cap 36, bit 38, exterior profile 40, tabs 42, and fasteners 44 of tool subassembly 16 are shown. Insulator 46, data pins 48, and power pins 50 of electrical connector 18 are shown. Balls 102 of locking mechanism 28 are also shown. Tool subassembly 16 and electrical connector 18 are received within shaft 28 of electro-mechanical head 14. Exterior components collar 30 and retainer 32 of electro-mechanical head 14 are removed to depict tool subassembly 16 and electrical connector 18 in greater detail in FIG. 2 and FIG. 3, which are discussed together.

Tool subassembly 16 and electrical connector 18 are mechanically attached to shaft 28 of electro-mechanical head 14 via fasteners 44. Cap 36 is a metallic body extending axially along axis A towards distal tip 14A. Cap 36 defines an internal cavity for housing components of locking mechanism 28, discussed further below. Exterior profile 40 of cap 36 is non-axisymmetric about axis A and defines an angular orientation of tool 10 about axis A with respect to the device required for engagement. For example, exterior profile 40 can include at least one flat surface 40A that conforms to a mating surface of the device (e.g., an opposing surface of a receptacle). In other examples, exterior profile 40 can include multiple flat surfaces 40A asymmetrically arranged about axis A that correspond to mating surfaces of the device. Accordingly, exterior profile 40 of cap 36 defines an angular orientation of electro-mechanical head 14 relative to the device, which can ensure electrical connector 18 correctly receives within the device receptacle.

Bit 38 attaches to cap 36 at distal end 14A and defines a driver profile. Bit 38 can include an external or internal thread that engages corresponding threads of cap 36. In other examples, bit 38 can be welded or otherwise bonded to cap 36. In still other examples, cap 36 and bit 38 can be integral, both components manufactured from the same material stock.

In the example depicted by FIG. 2 and FIG. 3, bit 38 has a hexagonal profile. In other examples, bit 38 can have a slot or flat profile, a coin-slot profile, a Hi-Torque® profile, a cross or double-slot profile, a Phillips® profile, a Phillips II® profile, a Pozidriv® profile, a Supadriv® profile, a Frearson® profile, a square Robertson® profile, a LOX-Recess® profile, a double-square profile, a triple-square profile, a double hex profile, an ASTER™ recess profile, a hexalobular or Torx® profile, a Torx Plus® profile, a Torx Paralobe® profile, a Torx ttap® profile, a spline profile, a triangular profile, a tri-point profile, or a combination of any of the forgoing profiles, among other possible profiles. In still other examples, bit 38 or cap 36 may define a socket profile corresponding to any of the foregoing profiles rather than a driver profile. For example, bit 38 can define a hexagonal socket rather than a hexagonal driver in some examples of tool 10.

Tool subassembly 16 can further include tabs 42 and fasteners 44 for joining tool subassembly 16 to shaft 28 of electro-mechanical head 14. Tabs 42 extend radially outward from cap 36 relative to axis A. To facilitate torque transmission, tool subassembly 16 includes at least two tabs spaced circumferentially about axis A. In the depicted example, tool subassembly 16 includes three tabs 42. Circumferential spacing of tabs 42 can be equal. In other examples, tabs 42 have an unequal circumferential spacing such that assembly of tool subassembly 16 to shaft 28 of electro-mechanical head 14 has a defined angular orientation. As shown in FIG. 3, tabs 42 have an equal circumferential spacing about axis A. Tool subassembly 16 can attach to shaft 28 via fasteners 44, which extend through clearance holes in each of tabs 42 into a threaded hole in shaft 28. Tabs 42 and fasteners 44 enable tool subassembly 16 to be replaced periodically to address wear and failure of tool subassembly 16 and/or to change driver or socket profile of bit 38.

Electrical connector 18 includes insulating body 46, and one or more data pins 36. In some examples, electrical connector 18 includes two or more power pins 38. Insulating body 46 conforms to a space between tool subassembly 16 and shaft 28. As depicted, insulating body 46 is a cylindrical body received within a bore of shaft 28. The cylindrical body includes a radially-extending slot for each tab 42 of tool subassembly 16. Each slot has an axial length along axis A that is less than an axial extent of insulating body 46 such that fasteners 44 extend through tabs 42 and insulating body 46 to attach insulating body 46 to shaft 28.

Data pins 36 and power pins 38 are electrically conductive members that extend through insulating body 46. In some examples, pins 36 and/or pins 38 can be spring-loaded pins known as pogo pins to improve durability of electrical connector 18. Data pins 36 are electrically connected computing device 24 via cable 20 to receive one or more parameters, information, and/or commands intended for a connected device. Power pins 38 provide AC or DC power to device. Insulating body 46 electrically isolated pins 36 and pins 38 and is constructed from a material with a breakdown voltage exceeding the voltages between pins 36 and/or pins 38. For example, insulating body 46 can be polyamide (Nylon), PEEK or ULTEM™ or other dielectric material while pins 36 and pins 38 can be copper, or another conductive metal.

Pins 36 and/or pins 38 are arranged within insulating body 46 according to a desired electrical interface. As depicted in FIG. 3, data pins 36 and power pins 38 are arranged at a constant radial distance R from axis A (i.e., a common radial circle). Further, electrical connector 18 includes six data pins 36 divided into two groups with three data pins 36 in each group and each group located between circumferentially adjacent tabs 42 of tool subassembly 16. Power pins 38 protrude through the remaining portion of insulating body 46. The depicted configuration benefits from a radially compact assembly. However, electrical connector 18 can have other arrangements of data pins 36 and/or power pins 38. In other examples, electrical connector 18 can have more or less data pins 36 and/or more or less power pins 38. In still other examples, electrical connector 18 can have one or more data pins 36 and zero power pins 38, or one or more power pins 38 and zero data pins 36.

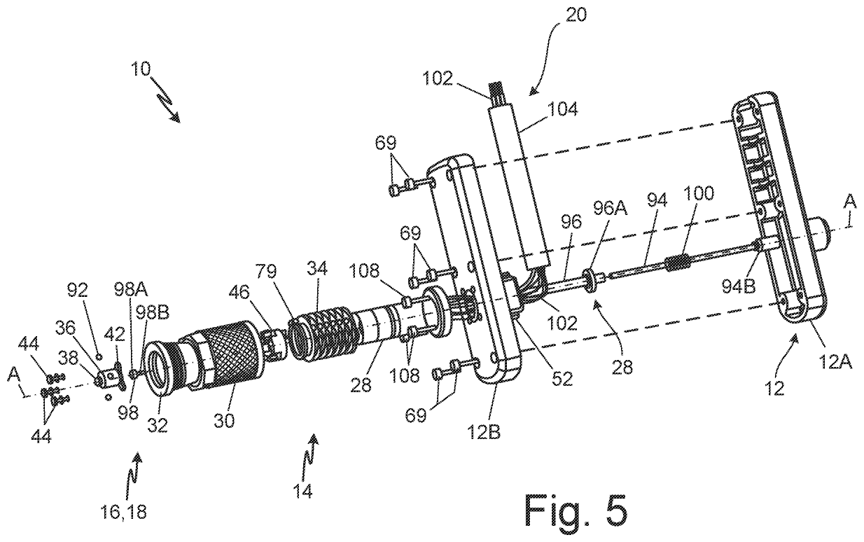

FIG. 4 is a cross-sectional view of tool taken along section C-C in FIG. 1. Housing 12, electro-mechanical head 14, tool subassembly 16, electrical connector 18, cable 20, and dust cover 22 are shown.

Housing 12 has a two-part design comprising a first half housing 12A (i.e., an upper half housing) and a second half housing 12B (i.e., a lower half housing), each of half housings 12A and 12B are shells bounding an interior space of the housing 12. First half housing 12A abuts second half housing 12B along mating surfaces 48 that extend about the housing perimeter. First half housing 12A includes pedestal 50 protruding exterior from housing 12 and second half housing 12B includes pedestal 52 protruding interior to housing 12. Each of pedestals 50 and 52 includes respective bores 54A-54B that are concentric to axis A and hence, concentric to corresponding bores 54C-E of shaft 28. Bores 54A-E are collectively referred to as bore 54, which extends along axis A and through housing 12 and electro-mechanical head 14. Each of bores 54A-E define a different segment of bore 54 and may have different lengths and diameters as well as be associated with different components of tool 10. Pedestal 52 additionally includes lateral bore 56 that extends from bore 54B to the interior of housing 12 for routing cable 20.

Housing 12 includes one or more internal ribs 58 that extend from an interior side of half housing 12A, and/or an interior side of half housing 12B, towards mating surface 48. Each rib 58 can include cutout 60 conforming to an outer periphery of cable 20 (i.e., protective cover 104). Collectively, cutouts 60 accommodate routing cable 20 within housing 12 of tool 10. In some examples, cutouts 60 can be configured to interfere with cable 20 to provide strain relief for cable 20. Cable protrudes through opening 62 defined by end walls of housings 12A and 12B.

To provide environmental protection to cable 20 and electrical connector 18, housing 12 can include one or more grooves 64A-C and seals 66A-C. In the depicted example, housing 12 includes seal 64A received within groove 66A, each extending along the periphery of housing 12 at mating surface 48. Further, housing 12 includes seal 66B and groove 66B circumscribing axis A at the interface between housing 12 and electro-mechanical head 14. Groove 66C receives seal 68C, each of which circumscribe axis A at an interface between pedestal 52 of second half housing 12B and first half housing 12A. Housing 12 can also include grommet 70 installed about cable 20 and received within opening 62. Some grommets 70 can also provide strain relief for cable 20. While seals 68A, 68B, and 66C are depicted as o-rings in the depicted example, seals 68A, 68B, and 66C can be a resilient metal seal (e.g., a C-seal, a W-seal, or an E-seal) in other examples. Further, seals 68A, 68B, and 66C can be replaced with gaskets in still other examples for which grooves 66A, 66B, and 66C can be omitted.

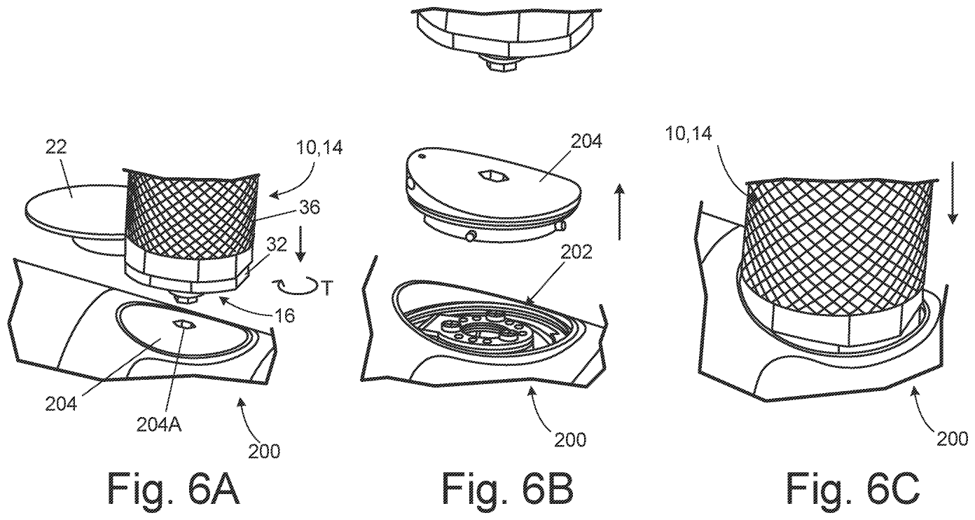

First half housing 12A and second half housing 12B are mechanically attached to each other to form housing 12. For example, second half housing 12B can be joined to first half housing 12A using fasteners 69 as shown in FIG. 5. Fasteners 69 extend through clearance holes of second half housing 12A and engage threaded holes formed by first half housing 12A. Heads of fasteners 69 can be recessed within second half housing 12B using counterbores as shown in FIG. 5.

Shaft 28 of electro-mechanical head 14 extends from housing 12 along axis A towards distal end 14A of tool 10. Shaft 28 is mechanically attached to housing 12. In the depicted example, shaft 28 includes flange 71 which facilitates attachment to housing 12 via fasteners 72 as shown in FIG. 5. In other examples, another mechanical attachment can be used to transmit torque applied by housing 12 about axis A to tool subassembly 16. Shaft 28 includes interior wall 74, which is disposed between bores 54C and 54E. Interior bore 54C extends from housing 12 to interior wall 74. Exterior bore 54E extends from interior wall 74 to a distal end of shaft 28 and receives tool subassembly 16 and electrical connector 18. Bore 54D extends through interior wall 74 to connect bore 54C to bore 54E. Circumferentially spaced about bore 54D, holes 76 permit leads of cable 20 to pass through interior wall 74 and attach to data pins 36 and/or power pins 38 of electrical connector 18.

Collar 30 and retainer 32 are cylindrical tubes that concentrically circumscribe shaft 28 and axis A. Collar 30 includes lip 78 that extends radially inward to engage snap ring 79 and spring 34. Retainer 32 is removably attached to collar 30 by, for example, a threaded connection. Retainer 32 defines a distal end face of electro-mechanical head 14. In some examples, retainer 32 traps a portion of dust cover 22 between collar 30 and retainer 32. Snap ring 79 is axially retained within an exterior groove of shaft 28. Spring 34 circumscribes shaft 28 and compresses between lip 78 of collar 30 and flange 71 of shaft 28 to bias collar 30 and retainer 32 towards distal end 14A of tool 10. When collar 30 abuts snap ring 79, components of tool subassembly 16 and electrical connector 18 are axially inboard of the distal end face of retainer 32 and/or a portion of collar 30 to provide mechanical protection for tool subassembly 16.

Dust cover 22 encloses an end of retainer 32 to provide additional protection for tool subassembly 16 and electrical connector 18. Dust cover 22 includes flat portion 82, cylindrical portion 84, hinge 86, and rib 88. Flat portion 82 caps an open end of electro-mechanical head 14. Hinge 86 extends from a periphery of flat portion 82 and is restrained between collar 30 and retainer 32. In the depicted example, collar 30 includes a slot to receive a portion of hinge 86. Retainer 32 overlaps the slot and hinge 86 to attach dust cover 22 to electro-mechanical head 14. Some examples of dust cover 22, such as the example depicted in FIG. 4, include cylindrical portion 84, which extends from flat portion 82 and is sized to be received within a bore of retainer 32. In further examples, dust cover 22 can include rib 88 which extends circumferentially around cylindrical portion 84. In such examples, retainer 32 includes circumferential extending groove 90 for receiving rib 88 of dust cover 22. Dust cover 22 provides environmental and mechanical protection for tool subassembly 16 and electrical connector 18 when tool 10 is not in use.

Locking mechanism 28 includes balls 92, actuation shaft 94, guide tube 96, locking cam 98 and spring 100. Guide tube 96 is a cylindrical tube that is concentric with axis A and is received within bores 54A-E of tool 10. Tube 96 is contained within housing 12 and extends from housing 12 into cap 36. Guide tube 96 includes flange 96A that extends radially outward from tube 96 relative to axis A. Flange 96A restrains guide tube 96 axially and laterally relative to housing 12. In the depicted example, flange 96A is trapped between housing halves 12A and 12B. Actuation shaft 94 is a cylindrical body concentric to axis A and guide tube 96. Shaft 94 extends through housing 12, electro-mechanical head 14, and guide tube 96 into cap 36.

Locking cam 98 mechanically attaches to the distal end of actuation shaft 94 by, for example, threaded attachment, a welded attachment, or other mechanical attachment. Locking cam 98 includes major portion 98A and minor portion 98B. The diameter of major portion 98A is larger than the diameter of minor portion 98B, which is axially inboard (i.e., disposed between major portion 98A and actuation shaft 94). The transition between major portion 98A and minor portion 98B defines a cam surface characterized by a smooth and continuous surface.

Actuation shaft 94 includes button end 94B that has a larger diameter relative to a longitudinal portion of shaft 94, which extends through guide tube 96. Button end 94B protrudes through housing 12 at an end opposite locking cam 98 and tool cap 36. Spring 100 is disposed about actuation shaft 94. Spring 100 compresses between button end 94A and flange 96A of guide tube 96 to bias actuation shaft 94 towards the button end 94B.

FIG. 4 depicts locking mechanism 28 a locking state in which spring 100 urges actuation shaft 94 towards the button end 94B causing major portion 98A of locking cam 98 to engage balls 92, which are displaced radially outward by locking cam 98 through apertures 36A in cap 36. Apertures 36A are sized to have a diameter smaller than the diameter of balls 92 and such that balls 92 protrude through cap 36. The degree to which balls 92 protrude beyond cap 36 affects a locking force imposed by tool 10 on an attached device. In a released state, actuation shaft 94 displaces along axis A towards cap 36, such as by hand depressing button end 96B inward, to permit balls 92 to engage minor portion 80B of locking cam 98. In the released state, balls 92 are retained within cap 36 such that no portion of balls 29 protrudes through apertures 36A. Once hand pressure is released from actuation shaft 94, spring 100 displaces actuation shaft 94 outward towards button end 96B to reengage balls 92 with major portion 98A of locking cam 98. Locking mechanism 28 permits tool subassembly 16 to be retained within a mechanical receptacle of the device such that electrical connector 18 remains attached to an electrical receptacle of the device in a hands-free manner.

Cable 20 includes leads 102, protective cover 104, and external connector 26. Each lead 102 is a wire wrapped individually with electrical insulation. Leads 102 are bound together by protective cover 104. External connector 26 is an electrical plug or receptacle that mates with a corresponding receptacle or plug of computing device 24. Each lead 102 of cable 20 connects electrical contacts of external connector 26 to one of data pins 36 or one of power pins 38 of electrical connector 18.

FIG. 5 is an exploded view depicting components of tool 10 displaced along axis A. Components of housing 12, electro-mechanical head 14, tool subassembly 16, electrical connector 18, and cable 20 are shown. The following example assembly sequence further describes relationships between and among components of tool 10. The described sequence is not intended to limit tool 10 in any way. The assembly of tool 10 can include additional steps, or described steps can be divided into multiple steps. Additionally, the assembly of tool 10 can proceed in a different logical order than the following example sequence.

Assembly of housing 12 includes inserting guide tube 96 through bore 54B of second half housing 12B until flange 96A abuts pedestal 52. Spring 100 is assembled with actuator shaft 94. With spring 100 installed, actuation shaft 94 inserted into guide tube 96. Subsequently, a length of protective cover 104 is removed from leads 102. Each lead 102 is guided through bore 54B or other holes of second half housing 12B exterior to guide tube 96. A portion of cable 20 comprising protective cover 104 is positioned within cutouts 60 of second half housing 12B. Seals 68A, 68B, and 68C are assembled into respective grooves 64A, 64B, and 64C of housing 12, if present. Bore 54A and cutouts 60 of first half housing 12A algin with button end 94B of actuation shaft 94 and cable 20, respectively. Fasteners 69 extend through counterbored clearance holes of second half housing 12B into threaded portions of first half housing 12A, retaining protective cover 104 of cable 20 in compression and compressing spring 100 of locking mechanism 28.

Assembly of electro-mechanical head 14 to housing 12 includes guiding leads 102, guide tube 96, and actuation shaft 94 through bores 54C-E of shaft 28 and attaching shaft 28 to second half housing 12B with fasteners 108. Leads 102 are soldered or crimped to one or more data pins 36 and/or one or more power pins 38. Data pins 36 and/or power pins 38 are pressed into insulation body 46 towards distal end 14A according to a predetermined pattern. After data pins 36 and/or power pins 38 are installed, insulation body 46 seats against interior wall 74 of shaft 28, with guide tube 96 and actuation shaft 94 protruding through insulation body 46. With actuation shaft 94 protruding from insulation body 46, locking cam 98 attaches to actuation shaft 94.

Tool subassembly 16 assembles to electro-mechanical head 14 by first installing balls 92 into tool cap 36 and temporarily retaining balls 92 within apertures 36A. Next, tool subassembly 16 is inserted into slots of insulation body 46 such that major portion 98A of locking cam 98 engages balls 92 of locking mechanism 28. Fasteners 44 are inserted through tabs 42 of cap 36 and corresponding holes of insulation body 46 to attach tool subassembly 16 and insulation body 46 to interior wall 74 of shaft 28. Bit 38 attaches to cap 36 before or after tool subassembly 16 attaches to shaft 28. Temporary restraint of balls 92 is removed once tool subassembly 16 attaches to shaft 28 and locking cam 80 engages balls 92.

Next, spring 34 and collar 30 are assembled about shaft 28. While compressing spring 34 with collar 30, snap ring 79 installs onto shaft 28 to retain spring 34 and collar 30 onto shaft 28. After snap ring 34 is installed, collar 30 is released such that spring 34 biases collar 30 against snap ring 79. Hinge 86 of dust cover 22 is inserted into an axial slot at a distal end of collar 30. Then, retainer 22 assembles to collar 30, thereby retaining dust cover 22 to collar 30. Cylindrical portion 84 and rib 58 of dust cover 22 are inserted into retainer bore and groove respectively.

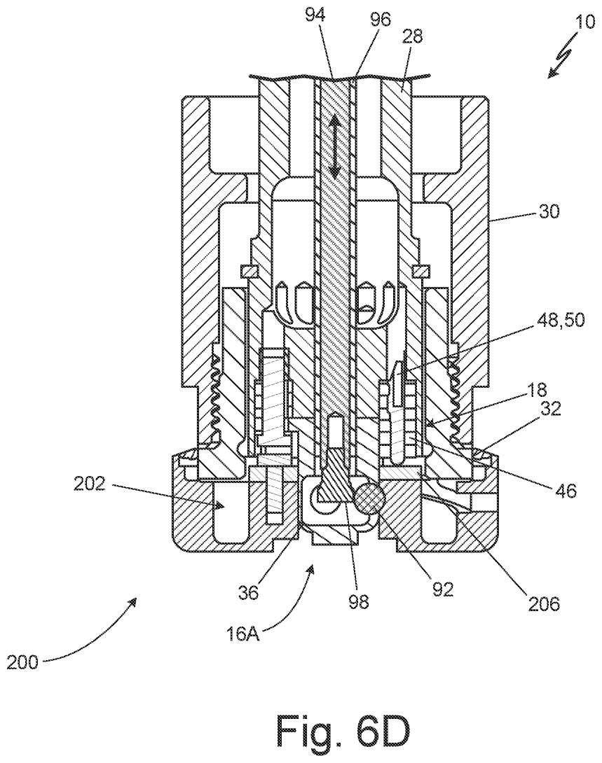

FIG. 6A, FIG. 6B, FIG. 6C, and FIG. 6D depict an example sequence using tool 10 to perform a mechanical task and an electrical task. In the example sequence, tool 10 is used to access fuze settings of munition 200. Munition 200 includes electrical receptacle 202 that mates with electrical connector 18 of tool 10. Electrical receptacle 202 is protected by access cover 204 that is removable using tool subassembly 16.

In FIG. 6A, collar 30 and retainer 32 are retracted to reveal tool subassembly 16. In practice, pressing tool subassembly 16 into a mating feature (e.g., tool socket 204A) of the access cover 204 depresses spring 34, allowing collar 30 and retainer 32 to displace axially to reveal tool subassembly 16. An operator applies torque T to the mating feature via housing 12, electro-mechanical head 14, and tool subassembly 16. Using tool subassembly 16, access cover 204 rotates to unlatch the access cover from munition 200. In FIG. 6B, an operator withdraws tool subassembly 16 and removes access cover 204 from munition 200. As shown, electrical receptacle 202 is accessible with access cover 204 removed. In FIG. 6C, an operator aligns tool subassembly 16 with mating mechanical features of the receptacle. In the example shown, exterior profile 40 of tool 10 aligns with corresponding mechanical features of receptacle 202. The operator depresses button 94B of locking mechanism 28 to translate actuation shaft 94 into a released position. Subsequently, tool subassembly 16 mates with corresponding features of the receptacle to guide engagement of electrical connector 18 with corresponding contacts of the receptacle. In FIG. 6D, tool 10 engages electrical receptacle of munition 200 such that pins 48 and/or pins 50 engage one or more contacts 206. Once engaged, the operator releases button 94B of locking mechanism 28. Balls 92 of locking mechanism 28 engage corresponding features of the receptacle to retain tool 10 in place without external support. While tool 10 is attached to device, electrical power and data passes from computing device 24 to munition to set fuze parameters of the munition. Once fuze parameters are transferred to munition, operator releases tool 10 from the receptacle by actuating locking mechanism 28 and replaces access cover using tool subassembly 16.

### Discussion of Possible Embodiments

The following are non-exclusive descriptions of possible embodiments of the present invention.

### An Electro-Mechanical Tool

A tool according to an example embodiment of this disclosure, among other possible things includes a handheld housing, an electro-mechanical head, and an electrical cable. The electro-mechanical head extends along an axis from the handheld housing to a distal end. The electro-mechanical head includes an electrical connector and a tool subassembly. The housing is operable to apply toque to the electro-mechanical head about the axis. The electrical cable comprises a plurality of leads extending through the electro-mechanical head and the handheld housing. The electrical connector includes a plurality of pins. Each of the pins is connected to one of the leads of the electrical cable. The tool subassembly comprises a bit attached to a cap.

The tool of the preceding paragraph can optionally include, additionally and/or alternatively, any one or more of the following features, configurations and/or additional components.

A further embodiment of the foregoing tool, wherein the bit can be distally located relative to the electrical connector.

A further embodiment of any of the foregoing tools, wherein the electrical connector can circumscribe the cap of the tool subassembly.

A further embodiment of any of the foregoing tools, wherein the electro-mechanical head can include a dust cover attached to the electro-mechanical head that encloses the tool subassembly and the electrical connector.

A further embodiment of any of the foregoing tools, wherein the electro-mechanical head can include a shaft extending towards the distal end along the axis.

A further embodiment of any of the foregoing tools, wherein the shaft can attach to the handheld housing.

A further embodiment of any of the foregoing tools, wherein the shaft can attach to the handheld housing at a flange.

A further embodiment of any of the foregoing tools, wherein the electro-mechanical head can include a collar coaxial with the shaft.

A further embodiment of any of the foregoing tools, wherein the electro-mechanical head can include a snap ring fitted in a groove of the shaft.

A further embodiment of any of the foregoing tools, wherein the electro-mechanical head can include a spring compressed between the flange and the collar to bias the collar towards the distal end against the snap ring.

A further embodiment of any of the foregoing tools, wherein the collar can circumscribe the electrical connector and the tool subassembly.

A further embodiment of any of the foregoing tools, wherein the collar can extend distally relative to the electrical connector and the tool subassembly.

A further embodiment of any of the foregoing tools, wherein the electro-mechanical head can include a retainer attached to the collar at the distal end.

A further embodiment of any of the foregoing tools, wherein the dust cover can be retained between the retainer and the collar.

A further embodiment of any of the foregoing tools, wherein the retainer can include a bore and a groove extending circumferentially about the bore.

A further embodiment of any of the foregoing tools, wherein the dust cover can include a flat portion and a cylindrical portion extending from the flat portion.

A further embodiment of any of the foregoing tools, wherein the dust cover can include a rib extending circumferentially about the cylindrical portion.

A further embodiment of any of the foregoing tools, wherein in a covered position, the bore of the retainer can receive the cylindrical portion of the dust cover.

A further embodiment of any of the foregoing tools, wherein in a covered position, the groove of the retainer can receive the rib of the dust cover.

A further embodiment of any of the foregoing tools, wherein an outer periphery of the cap can include at least one flat surface to define a non-axisymmetric profile about the axis.

A further embodiment of any of the foregoing tools, wherein the electrical connector can include an insulating body circumscribing the cap.

A further embodiment of any of the foregoing tools, wherein the plurality of pins can protrude through the insulating body from the leads towards the distal end.

A further embodiment of any of the foregoing tools, wherein each of the plurality of pins can be positioned along a common radius from the axis.

A further embodiment of any of the foregoing tools, wherein the plurality of pins can include at least two power pins connected to a computing device.

A further embodiment of any of the foregoing tools, wherein the plurality of pins can include at least one data pin connected to a computer device.

A further embodiment of any of the foregoing tools, wherein the housing can include a first half housing and a second half housing joined to the first half housing.

A further embodiment of any of the foregoing tools can further include a seal received with a groove of the second half housing that extends along a peripheral mating surface between the first half housing and the second half housing.

A further embodiment of any of the foregoing tools, wherein the locking mechanism can include a tube concentric with the axis.

A further embodiment of any of the foregoing tools, wherein the tube of the locking mechanism can include a flange retained between the first half housing and the second half housing.

A further embodiment of any of the foregoing tools, wherein the locking mechanism can include an actuation shaft extending concentrically with the axis through the handheld housing and the tube into the cap of the tool subassembly.

A further embodiment of any of the foregoing tools, wherein the actuation shaft can include a button end protruding from the handheld housing opposite the tool subassembly.

A further embodiment of any of the foregoing tools, wherein the locking mechanism can include a spring disposed between the flange of the guide tube and the button end of the actuation shaft to bias the actuation shaft towards the button end of the handheld housing.

A further embodiment of any of the foregoing tools, wherein the locking mechanism can include a locking cam attached to the actuation shaft.

A further embodiment of any of the foregoing tools, wherein the locking cam can include a major diameter section located at a distal end of the locking mechanism and a minor diameter section attached to the actuation shaft.

A further embodiment of any of the foregoing tools, wherein the locking mechanism can include a plurality of balls retained with the cap of the tool subassembly.

A further embodiment of any of the foregoing tools, wherein in a locked position of the locking mechanism, the actuation shaft can be biased against the housing by the spring, and the major section of the locking cam engages the balls into apertures of the cap.

A further embodiment of any of the foregoing tools, wherein in an unlocked position of the locking mechanism, the actuation shaft is displaced towards the distal end such that the minor section of the locking cam receives the plurality of balls.

A further embodiment of any of the foregoing tools, wherein the first half housing and the second half housing can include a plurality of internal ribs.

A further embodiment of any of the foregoing tools, wherein the plurality of ribs of the first half housing and the second half housing can include respective cutouts conforming to the electrical cable.

A further embodiment of any of the foregoing tools, wherein the plurality of ribs can compress the electrical cable.

A further embodiment of any of the foregoing tools, wherein the plurality of pins of the electrical connector can be circumferentially spaced about the tool subassembly.

A further embodiment of any of the foregoing tools, wherein the electrical connector can be received in a bore of the electro-mechanical head shaft.

A further embodiment of any of the foregoing tools, wherein the tool subassembly can be received within the bore of the electro-mechanical head shaft.

A further embodiment of any of the foregoing tools, wherein the insulating body of the electrical connector can include a plurality of slots.

A further embodiment of any of the foregoing tools, wherein the tool subassembly can include a plurality of tabs.

A further embodiment of any of the foregoing tools, wherein each tab of the plurality of tabs can be received within one of the slots of the insulation body.

A further embodiment of any of the foregoing tools, wherein the electro-mechanical head can include a plurality of fasteners, each fastener extending through one of the plurality of tabs and the insulating body to attach the electrical connector and the tool subassembly to the shaft of the electro-mechanical head.

A further embodiment of any of the foregoing tools, wherein the tool can include a computing device connected to the cable via an external connector.

A further embodiment of any of the foregoing tools, wherein the computing device can be operable to transmit electrical power and data through the cable to the electrical connector.

A further embodiment of any of the foregoing tools, wherein the exterior of the handheld housing can be contoured to define a hand grip.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A tool comprising:
a handheld housing;
an electro-mechanical head extending along an axis from the handheld housing to a distal end, the handheld housing operable to apply torque to the electro-mechanical head about the axis; and
an electrical cable comprising a plurality of leads extending through the electro-mechanical head and the handheld housing,
wherein the electro-mechanical head comprises:
an electrical connector comprising a plurality of pins, each of the pins connected to one of the leads of the electrical cable;
a tool subassembly comprising a bit attached to a cap, wherein the bit is distally located relative to the electrical connector; and
a locking mechanism operatively associated with the tool subassembly.

2. The tool of claim 1, wherein the electro-mechanical head further comprises:
a dust cover attached to the electro-mechanical head that encloses the tool subassembly and the electrical connector.

3. The tool of claim 1, wherein the electro-mechanical head further comprises:
a shaft extending towards the distal end along the axis, wherein the shaft attaches to the handheld housing at a flange;
a collar coaxial with the shaft;
a snap ring fitted in a groove of the shaft; and
a spring compressed between the flange and the collar to bias the collar towards the distal end against the snap ring,
wherein the collar circumscribes the electrical connector and the tool subassembly.

4. The tool of claim 3, wherein the electro-mechanical head further comprises:
a retainer attached to the collar at the distal end, wherein the dust cover is retained between the retainer and the collar.

5. The tool of claim 4,
wherein the retainer comprises:
a bore; and
a groove extending circumferentially about the bore; and
wherein the dust cover comprises:
a flat portion;
a cylindrical portion extending from the flat portion; and
a rib extending circumferentially about the cylindrical portion, wherein in a covered position, the bore of the retainer receives the cylindrical portion of the dust cover, and the groove of the retainer receives the rib of the dust cover.

6. The tool of claim 1, wherein an outer periphery of the cap includes at least one flat surface to define a non-axisymmetric profile about the axis.

7. The tool of claim 1, wherein the electrical connector comprises:
an insulating body circumscribing the cap, wherein the plurality of pins protrude through the insulating body from the leads towards the distal end.

8. The tool of claim 7, wherein each of the plurality of pins is positioned along a common radius from the axis.

9. The tool of claim 7, wherein the plurality of pins comprises at least two power pins connected to a power source and at least one data pin connected to a computing device.

10. The tool of claim 1, wherein the housing comprising:
a first half housing; and
a second half housing joined to the first half housing.

11. The tool of claim 10, further comprising:
a seal received within a groove of the second half housing that extends along a peripheral mating surface between the first half housing and the second half housing.

12. The tool of claim 10, wherein the locking mechanism comprises:
a tube concentric with the axis, the tube comprising a flange retained between the first half housing and the second half housing of the handheld housing;
an actuation shaft extending concentric with the axis through the handheld housing and the tube into the cap of the tool subassembly, wherein the actuation shaft comprises a button end protruding from the handheld housing opposite the tool subassembly;
a spring disposed between the flange and the button end to bias the actuation shaft towards the button end of the handheld housing;
a locking cam attached to the actuation shaft, the locking cam having a major diameter section located at a distal end of the locking mechanism and a minor diameter section attached to the actuation shaft; and
a plurality of balls retained within the cap of the tool subassembly, wherein in a locked position, the actuation shaft is biased against the housing and the major section of the locking cam engages the balls into apertures of the cap, and wherein in an unlocked position, the actuation shaft is displaced towards the distal end such that the minor section receives the plurality of balls.

13. The tool of claim 10, wherein the first half housing and the second half housing include a plurality of internal ribs, each of the ribs comprising a cutout conforming to the electrical cable, wherein the ribs compress the electrical cable.

14. A tool comprising:
a handheld housing;
an electro-mechanical head extending along an axis from the handheld housing to a distal end, the handheld housing operable to apply torque to the electro-mechanical head about the axis; and
an electrical cable comprising a plurality of leads extending through the electro-mechanical head and the handheld housing,
wherein the electro-mechanical head comprises:
an electrical connector comprising a plurality of pins, each of the pins connected to one of the leads of the electrical cable; and
a tool subassembly comprising a bit attached to a cap, wherein the bit is distally located relative to the electrical connector, and wherein the pins are circumferentially spaced about the tool subassembly.

15. The tool of claim 14, wherein the electro-mechanical head further comprises:
a shaft extending towards the distal end along the axis, wherein the shaft attaches to the handheld housing at a flange;
a collar coaxial with the shaft;
a snap ring fitted in a groove of the shaft; and
a spring compressed between the flange and the collar to bias the collar towards the distal end against the snap ring, wherein the electrical connector and the tool subassembly are received within a bore of the shaft at a distal end of the electro-mechanical head.

16. The tool of claim 14, wherein the electrical connector comprises:
an insulating body circumscribing the cap, wherein the plurality of pins protrude through the insulating body from the leads towards the distal end.

17. The tool of claim 16, wherein the insulating body comprises a plurality of slots, and wherein the tool subassembly comprises a plurality of tabs, and wherein each tab of the plurality of tabs is received within one of the slots of the insulation body.

18. The tool of claim 17, wherein the electro-mechanical head further comprises:
a plurality of fasteners, each fastener extending through one of the plurality of tabs and the insulating body to attach the electrical connector and the tool subassembly to the shaft.

19. The tool of claim 14, further comprising:
a computing device connected to the cable via an external connector, wherein the computing device is operable to transmit electrical power and data through the cable to the electrical connector.

20. The tool of claim 14, wherein an exterior of the handheld housing is contoured to define a hand grip.
